(19) United States
(12) Patent Application Publication
(10) Pub. No.: US 2026/0302987 A1
(43) Pub. Date: Oct. 1, 2026

(54) MOTOR CONTROLLER AND MOTOR CONTROL SYSTEM

(71) Applicant: Mitsubishi Electric Corporation, Tokyo (JP)

(72) Inventors: Shinji OKUMURA, Tokyo (JP); Hidetoshi IKEDA, Tokyo (JP); Hiroyuki SEKIGUCHI, Tokyo (JP)

(73) Assignee: Mitsubishi Electric Corporation, Tokyo (JP)

(21) Appl. No.: 19/479,414

(22) PCT Filed: May 29, 2023
(86) PCT No.: PCT/JP2023/019940

§ 371 Date: Oct. 28, 2025

(51) Int. Cl. H02P 23/04; H02P 23/14

(52) U.S. Cl. CPC H02P 23/04; H02P 23/14

(57) ABSTRACT

A motor controller that switches between position control and non-position control over an object includes a reference model unit that determines a model position that is a filtered position command, a model initial value setting unit that sets a model position initial value, based on a detected position at a time of switching from the non-position control to the position control, the model position initial value being used to calculate the model position, and a position command initial value setting unit that sets a position command initial value used to generate the position command. At the time of switching, the position command initial value is set, based on velocity information of the object at the time of switching, the detected position, and a filter transfer characteristic, and a torque command corresponding to the position command generated based on the position command initial value is output to a drive device.

### FIELD

The present disclosure relates to a motor controller to control a motor and a motor control system.

### BACKGROUND

A mechanical apparatus such as an elevator or a machine tool operates with a motor included in the mechanical apparatus controlled by a motor controller. The motor controller may switch from velocity control to position control to control the mechanical apparatus. At the time of this switching, the mechanical operation may suddenly changes. Therefore, it is desired to prevent a sudden change in the mechanical operation.

A mechanical operation control device described in Patent Literature 1 prevents a sudden change in mechanical operation by matching a position command at the time of switching from velocity control to position control to a detected position detected from an object under control.

### CITATION LIST

### Patent Literature

Patent Literature 1: Japanese Patent Application Laid-open No. H11-212650

### SUMMARY OF INVENTION

### Problem to be Solved by the Invention

However, when a filter such as a low-pass filter for smoothing a mechanical operation corresponding to the position command is applied to the technique of Patent Literature 1, filtering causes a signal delay, and the mechanical operation may suddenly change at the time of switching from the velocity control to the position control.

The present disclosure has been made in view of the above. It is an object of the present disclosure to provide a motor controller capable of preventing a sudden change in a mechanical operation corresponding to a position command while smoothing the mechanical operation.

### Means to Solve the Problem

In order to solve the above-described problem and achieve the object, the present disclosure provides a motor controller to control an object to be driven, switching between position control over the object and non-position control that is a control mode different from the position control, the motor controller including: a position command generation unit to generate a position command that is a command for the position control; and a non-position command generation unit to generate a non-position command that is a command for the non-position control. The motor controller of the present disclosure also includes: a reference model unit to filter the position command with a filter, to determine a model position indicating a position corresponding to the filtered position command; and a velocity control unit to determine, during the position control, a first torque command to drive the object, using a signal calculated based on the model position and a detected position that is a position detected on the object. The motor controller of the present disclosure further includes: a model initial value setting unit to set a model position initial value, based on the detected position at a time of switching from the non-position control to the position control, the model position initial value being a signal used to calculate the model position at the time of switching; and a position command initial value setting unit to set a position command initial value that is a signal used to generate the position command at the time of switching. The motor controller outputs, during the non-position control, a second torque command corresponding to the non-position command to drive the object, to a drive device to drive the object. The position command initial value setting unit sets the position command initial value, based on velocity information, the detected position at the time of switching, and a transfer characteristic, the velocity information being a signal related to a velocity of the object at the time of switching, the transfer characteristic being a characteristic of a transfer function of the filter. The position command generation unit generates the position command at the time of switching, based on the position command initial value, and the velocity control unit outputs, at the time of switching, the first torque command corresponding to the position command at the time of switching, to the drive device.

### Effects of the Invention

The motor controller according to the present disclosure has an advantage of being able to prevent a sudden change in a mechanical operation corresponding to the position command while smoothing the mechanical operation.

### BRIEF DESCRIPTION OF DRAWINGS

FIG. 1 is a diagram illustrating a configuration of a motor controller according to a first embodiment.

FIG. 2 is a diagram for explaining an example of an operation pattern of an object that operates under motor control by the motor controller according to the first embodiment.

FIG. 3 is a block diagram illustrating a configuration of a position control unit included in the motor controller according to the first embodiment.

FIG. 4 is a block diagram illustrating a configuration of a velocity control unit included in the motor controller according to the first embodiment.

FIG. 5 is a block diagram illustrating a configuration of a reference model unit included in the motor controller according to the first embodiment,

FIG. 6 is a block diagram illustrating a configuration of a position command generation unit included in the motor controller according to the first embodiment.

FIG. 7 is a block diagram illustrating a configuration of a reference model unit included in a motor controller according to a second embodiment.

FIG. 8 is a block diagram illustrating a configuration of a motor controller according to a third embodiment.

FIG. 9 is a block diagram illustrating a configuration of a reference model unit included in the motor controller according to the third embodiment.

FIG. 10 is a block diagram illustrating a configuration of a velocity control unit included in the motor controller according to the third embodiment.

### DESCRIPTION OF EMBODIMENTS

Hereinafter, a motor controller and a motor control system according to embodiments of the present disclosure will be described in detail with reference to the drawings.

### First Embodiment

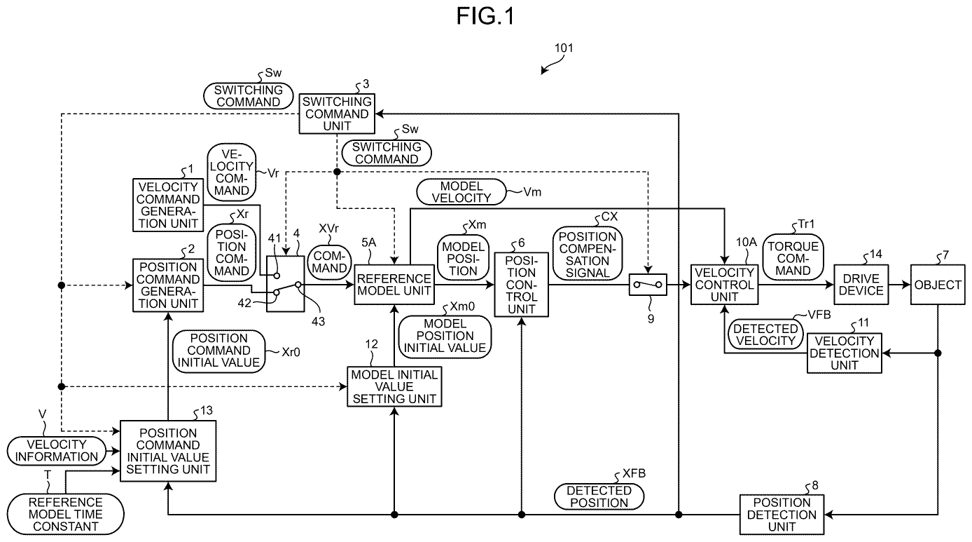

FIG. 1 is a diagram illustrating a configuration of a motor controller according to a first embodiment. A motor controller 101 is a device to control an object 7 that is a mechanical apparatus (object to be controlled) such as an elevator or a machine tool. The motor controller 101 controls a motor (not illustrated) included in the object 7 to control the object 7.

The motor controller 101 drives the object 7 to be driven, switching between position control and non-position control that is a control mode different from the position control over the object 7. The non-position control in the first embodiment and a second embodiment is velocity control, and the non-position control in a third embodiment is torque control.

The motor controller 101 includes a velocity command generation unit 1, a position command generation unit 2, a switching command unit 3, a switch 4, a reference model unit 5A, and a position control unit 6. The motor controller 101 also includes a position detection unit 8, a switch 9, a velocity control unit 10A, a velocity detection unit 11, a model initial value setting unit 12, and a position command initial value setting unit 13.

The motor controller 101 is connected to a drive device 14 and outputs a torque command Tr1 to the drive device 14. Consequently, the drive device 14 outputs a drive command (current) that is a signal to drive the object 7 to the motor of the object 7, based on the torque command Tr1. In the first embodiment, a system including the motor controller 101, the drive device 14, and the object 7 is a motor control system.

The velocity command generation unit 1 generates a velocity command Vr that is a velocity command to operate the object 7 at a specific velocity (non-position control command). The velocity command generation unit 1 sends the velocity command Vr to the switch 4. In the first and second embodiments, the velocity command generation unit 1 is a non-position command generation unit. In the first and second embodiments, the velocity command Vr generated by the velocity command generation unit 1 is a non-position command.

The position command generation unit 2 accepts (receives) a position command initial value Xr0 from the position command initial value setting unit 13, and accepts a switching command Sw from the switching command unit 3. Based on the position command initial value Xr0 sent from the position command initial value setting unit 13, the position command generation unit 2 generates a position command Xr that is a command to move the object 7 to a specific position (position control command). The position command initial value Xr0 will be described below. The position command generation unit 2 sends the position command Xr to the switch 4.

The switching command unit 3 generates the switching command Sw that is a command to switch between the velocity control and the position control. The switching command unit 3 monitors, for example, an actual remaining distance Xea that is the difference between a target stop position (hereinafter, referred to as a target stop position Xt) and a detected position XFB. The target stop position Xt is a target position at which to stop the object 7. The switching command unit 3 acquires the target stop position Xt from a control program used to control the motor. The detected position XFB is the actual position of the object 7 detected by the position detection unit 8. The detected position XFB corresponds to the feedback value of the position of the object 7.

When the actual remaining distance Xea is greater than or equal to a specific value, the switching command unit 3 outputs, for example, “0” as the switching command Sw to move the object 7 under the velocity control. When the actual remaining distance Xea is less than the specific value, the switching command unit 3 outputs, for example, “1” as the switching command Sw to move the object 7 under the position command Xr. The switching command unit 3 sends the switching command Sw to the position command generation unit 2, the switch 4, the reference model unit 5A, the switch 9, the model initial value setting unit 12, and the position command initial value setting unit 13.

The switch 4 includes terminals 41 to 43. The terminal 41 is connected to the velocity command generation unit 1, and the terminal 42 is connected to the position command generation unit 2. The terminal 43 is connected to the reference model unit 5A.

The switch 4 switches the connection destination of the terminal 43 to the terminal 41 or the terminal 42, based on the switching command Sw sent from the switching command unit 3. The switch 4 connects the terminal 43 to the terminal 41 in a period in which the velocity control is performed (a velocity control interval Vs described below), and connects the terminal 43 to the terminal 42 in a period in which the position control is performed (a position control interval Ps described below). The output of the switch 4 is referred to as a command XVr. That is, the switch 4 outputs the velocity command Vr as the command XVr in the velocity control interval Vs, and outputs the position command Xr as the command XVr in the position control interval Ps. The switch 4 outputs the command XVr to the reference model unit 5A.

The reference model unit 5A receives the command XVr from the switch 4, receives the model position initial value Xm0 from the model initial value setting unit 12, and receives the switching command Sw from the switching command unit 3. The model position initial value Xm0 will be described below.

The reference model unit 5A performs processing to smooth the operation of the object 7 on the command XVr. That is, the reference model unit 5A performs processing to smoothly change the actual position of the object 7 on the command XVr.

The reference model unit 5A switches between processing in the velocity control interval Vs and processing in a model position Xm, based on the switching command Sw. The reference model unit 5A performs processing using the velocity command Vr when the switching command Sw is a command to switch to the velocity control, and performs processing using the position command Xr when the switching command Sw is a command to switch to the position control.

The reference model unit 5A performs operations based on the command XVr to calculate a model velocity Vm and a model position Xm. The reference model unit 5A may not calculate the model position Xm in the velocity control interval Vs.

At the time of switching from the velocity control interval Vs to the position control interval Ps, the reference model unit 5A performs operations based on the command XVr and the model position initial value Xm0, to calculate the model velocity Vm and the model position Xm.

The model velocity Vm is a velocity calculated using a filter such as a low-pass filter included in the reference model unit 5A. The model position Xm is a position calculated using the filter such as the low-pass filter included in the reference model unit 5A. Thus, the model position Xm is a signal obtained through the filter such as the low-pass filter. The model position Xm is delayed with respect to the position command Xr by a time that depends on the filter characteristic.

The model position Xm and the model velocity Vm are in the relationship of differentiation and integration. That is, the model velocity Vm is obtained by differentiating the model position Xm with respect to time, and the model position Xm is obtained by integrating the model velocity Vm with respect to time. The model position Xm substantially matches the actual velocity of the object 7 (detected velocity VFB described below).

Since the model velocity Vm and the model position Xm are calculated using the filter, the object 7 operates smoothly according to the filter characteristic. In the first embodiment, during the position control, control is performed such that the model position Xm matches the detected position XFB that is the feedback position of the object 7.

If the motor controller 101 controls the object 7 without using the reference model unit 5A, the motor of the object 7 is affected by vibration, noise, etc. and prevented from operating smoothly. Therefore, in the first embodiment, the motor controller 101 controls the object 7 using the reference model unit 5A.

The model velocity Vm and the model position Xm vary according to the command XVr sent from the switch 4. In the velocity control interval Vs, the model velocity Vm and the model position Xm vary according to the velocity command Vr. In the position control interval Ps, the model velocity Vm and the model position Xm vary according to the position command Xr. The model velocity Vm and the model position Xm at the time of switching from the velocity control interval Vs to the position control interval Ps correspond to the position command Xr and the model position initial value Xm0. The reference model unit 5A outputs the model velocity Vm to the velocity control unit 10A, and outputs the model position Xm to the position control unit 6.

The position control unit 6 receives the model position Xm from the reference model unit 5A, and receives the detected position XFB from the position detection unit 8. The position control unit 6 performs an operation based on the model position Xm and the detected position XFB, to calculate a position compensation signal CX. The position control unit 6 outputs the calculated position compensation signal CX to the switch 9. The position compensation signal CX is a signal to compensate for the position of the object 7. In other words, the position compensation signal CX is a signal to correct the positional deviation of the object 7. The position compensation signal CX is indicated by velocity information. The model position Xm, the position control unit 6, and the position compensation signal CX are used in the position control interval Ps.

The switch 9 receives the switching command Sw from the switching command unit 3, and receives the position compensation signal CX from the position control unit 6. The switch 9 is a switch that is turned on in the position control interval Ps and is turned off in the velocity control interval Vs, based on the switching command Sw. The switch 9 is turned on to output the position compensation signal CX to the velocity control unit 10A, and is turned off to interrupt the output of the position compensation signal CX to the velocity control unit 10A. The switch 9 may be disposed between the reference model unit 5A and the position control unit 6. Alternatively, the switch 9 may be disposed downstream of a low-pass filter 5d described below in the reference model unit 5A.

The velocity control unit 10A receives the model velocity Vm from the reference model unit 5A, and receives the detected velocity VFB from the velocity detection unit 11. The detected velocity VFB is the actual velocity of the object 7 detected by the velocity detection unit 11. The detected velocity VFB corresponds to the feedback value of the velocity of the object 7. The velocity control unit 10A receives the position compensation signal CX from the switch 9 in the position control interval Ps, and does not receive the position compensation signal CX from the switch 9 in the velocity control interval Vs.

In the position control interval Ps, the velocity control unit 10A performs an operation based on the position compensation signal CX, the model velocity Vm, and the detected velocity VFB, thereby calculating the torque command Tr1 that determines the torque of the motor. In the velocity control interval Vs, the velocity control unit 10A performs an operation based on the model velocity Vm and the detected velocity VFB, thereby calculating the torque command Tr1. The velocity control unit 10A outputs the calculated torque command Tr1 to the drive device 14.

In the first and second embodiments, the torque command Tr1 calculated and output in the position control interval Ps by the velocity control unit 10A is a first torque command, and the torque command Tr1 calculated and output in the velocity control interval Vs by the velocity control unit 10A is a second torque command.

The drive device 14 outputs, to the object 7, a drive command that is a signal to drive the object 7, based on the torque command Tr1 sent from the velocity control unit 10A that is a torque control unit.

The position detection unit 8 detects the position of the object 7 and outputs the detected position XFB that is information indicating the position of the object 7. The position detection unit 8 uses, for example, an encoder to detect the position. The position detection unit 8 sends the detected position XFB to the switching command unit 3, the position control unit 6, the model initial value setting unit 12, and the position command initial value setting unit 13.

The velocity detection unit 11 detects the velocity of the object 7 and outputs the detected velocity VFB that is information indicating the velocity of the object 7 to the velocity control unit 10A. The velocity detection unit 11 can obtain the detected velocity VFB by differentiating the position detected by the encoder or the like, for example. Alternatively, the velocity detection unit 11 may estimate the detected velocity VFB, based on at least one of the voltage and the current generated in the drive device 14.

The model initial value setting unit 12 receives the detected position XFB from the position detection unit 8 and receives the switching command Sw from the switching command unit 3. Upon receiving the switching command Sw to switch to the position control from the switching command unit 3, the model initial value setting unit 12 performs an operation based on the detected position XFB to calculate the model position initial value Xm0. The model position initial value Xm0 is a signal used to calculate the model position Xm at the time of switching from the velocity control interval Vs to the position control interval Ps. The model initial value setting unit 12 sends the calculated model position initial value Xm0 to the reference model unit 5A.

The position command initial value setting unit 13 receives the detected position XFB from the position detection unit 8 and receives the switching command Sw from the switching command unit 3. The position command initial value setting unit 13 receives velocity information V and a reference model time constant T. The velocity information V is, for example, the model velocity Vm. In this case, the position command initial value setting unit 13 receives the model velocity Vm from the reference model unit 5A as the velocity information V. The position command initial value setting unit 13 in this case is connected to the reference model unit 5A, although FIG. 1 does not illustrate a connection line connecting the position command initial value setting unit 13 and the reference model unit 5A. The first embodiment describes a case where the velocity information V is the model velocity Vm.

Note that the velocity information V may be the velocity command Vr or the detected velocity VFB. When the velocity information V is the velocity command Vr, the position command initial value setting unit 13 receives the velocity command Vr from the velocity command generation unit 1 as the velocity information V. The position command initial value setting unit 13 in this case is connected to the velocity command generation unit 1.

When the velocity information V is the detected velocity VFB, the position command initial value setting unit 13 receives the detected velocity VFB from the velocity detection unit 11 as the velocity information V. The position command initial value setting unit 13 in this case is connected to the velocity detection unit 11.

The reference model time constant T corresponds to a characteristic of the filter such as the low-pass filter (transfer function) included in the reference model unit 5A. Here, the reference model time constant T is the time constant of the transfer function. Note that the position command initial value setting unit 13 may receive information other than the reference model time constant T as long as the information is a characteristic related to the transfer function (transfer characteristic). The position command initial value setting unit 13 reads the reference model time constant T from, for example, memory that has stored the reference model time constant T in advance, or the like.

Upon receiving the switching command Sw to switch to the velocity control from the switching command unit 3, the position command initial value setting unit 13 performs an operation based on the velocity information V (model velocity Vm), the reference model time constant T, and the detected position XFB, to calculate the position command initial value Xr0. The position command initial value Xr0 is a signal used to generate the position command Xr at the time of switching from the velocity control interval Vs to the position control interval Ps.

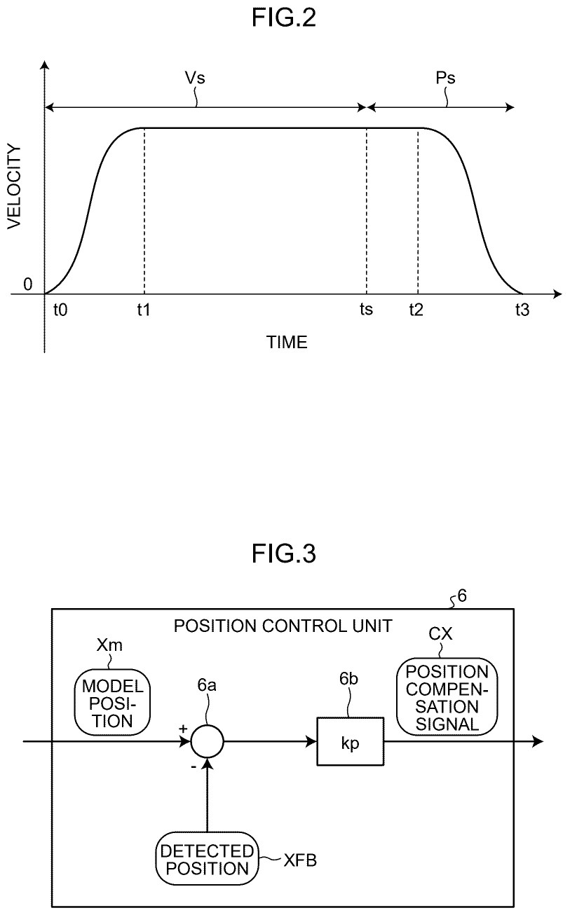

Here, an operation of the object 7 will be described. FIG. 2 is a diagram for explaining an example of an operation pattern of the object that operates under motor control by the motor controller according to the first embodiment. The horizontal axis of the graph illustrated in FIG. 2 is time, and the vertical axis is the velocity of the object 7.

In the first embodiment, the object 7 includes the motor (not illustrated) and a mobile object (not illustrated) that moves as the motor is driven. At and before time to, the object 7 is stationary. At time to, the object 7 starts to accelerate, and the velocity gradually increases until time t1. The period from time to to time t1 is referred to as an acceleration interval. The velocity of the object 7 becomes maximum at time t1, and then the object 7 is driven at a constant velocity until time t2. The interval from time t1 to time t2 is referred to as a constant velocity interval.

From time t2, the object 7 decelerates, and the velocity gradually decreases. At time t3, the velocity of the object 7 becomes zero, and the object 7 stops at the target stop position Xt. The interval from time t2 to time t3 is referred to as a deceleration interval. Here, the object 7 is driven under the velocity control from time to to a switching time ts, and is driven under the position control from the switching time ts to time t3. The switching time ts is the time to switch from the velocity control to the position control. The interval from time to to the switching time ts is referred to as the velocity control interval Vs. The interval from the switching time ts to time t3 is referred to as the position control interval Ps.

Next, the operation of the motor controller 101 will be described. In the velocity control interval Vs, the switching command Sw is “O”, and the switch 4 connects the terminal 43 to the terminal 41. Consequently, the velocity command Vr, which is the output of the velocity command generation unit 1, is input to the reference model unit 5A as the command XVr.

Under the switching command Sw, the switch 9 is turned off, so that the position compensation signal CX, which is the output of the position control unit 6, is not input to the velocity control unit 10A. The velocity control unit 10A in this case performs an operation based on the model velocity Vm and the detected velocity VFB to determine the torque command Tr1.

When the switching command Sw becomes “1”, the object 7 is driven under the position control. In the position control interval Ps, the switch 4 connects the terminal 43 to the terminal 42. Consequently, the position command Xr, which is the output of the position command generation unit 2, is input to the reference model unit 5A as the command XVr.

The switch 9 is turned on in the position control interval Ps, so that the position compensation signal CX, which is the output of the position control unit 6, is input to the velocity control unit 10A. The velocity control unit 10A in this case performs an operation based on the position compensation signal CX, which is the output of the position control unit 6, the model velocity Vm, and the detected velocity VFB, to determine the torque command Tr1.

At the time when the switching command Sw switches from “O” to “1”, that is, at the switching time (time of switching) ts to switch from the velocity control to the position control, the position command initial value setting unit 13 determines the position command initial value Xr0 with a method described below, and the position command generation unit 2 determines the position command Xr based on the position command initial value Xr0. At the switching time ts of switching from the velocity control to the position control, the reference model unit 5A determines the model position Xm based on the model position initial value Xm0 calculated with a method described below.

### <Position Control Unit 6>

FIG. 3 is a block diagram illustrating a configuration of the position control unit included in the motor controller according to the first embodiment. The position control unit 6 includes an arithmetic unit 6a and a position proportional gain 6b. The arithmetic unit 6a receives the model position Xm from the reference model unit 5A and receives the detected position XFB from the position detection unit 8. The arithmetic unit 6a calculates the difference between the model position Xm and the detected position XFB and sends the calculation result to the position proportional gain 6b.

The position proportional gain 6b multiplies the output value from the arithmetic unit 6a by kp. Here, kp is the proportional gain (proportional strength). The output from the position proportional gain 6b is the position compensation signal CX. The position proportional gain 6b outputs the position compensation signal CX to the switch 9. Thus, the position control unit 6 controls the position of the object 7 with proportional (P) control. That is, the position control unit 6 sets the position compensation signal CX to a value proportional to the difference between the model position Xm that is a target value and the detected position XFB that is a current value, to proportionally control the position of the object 7.

### <Velocity Control Unit 10A>

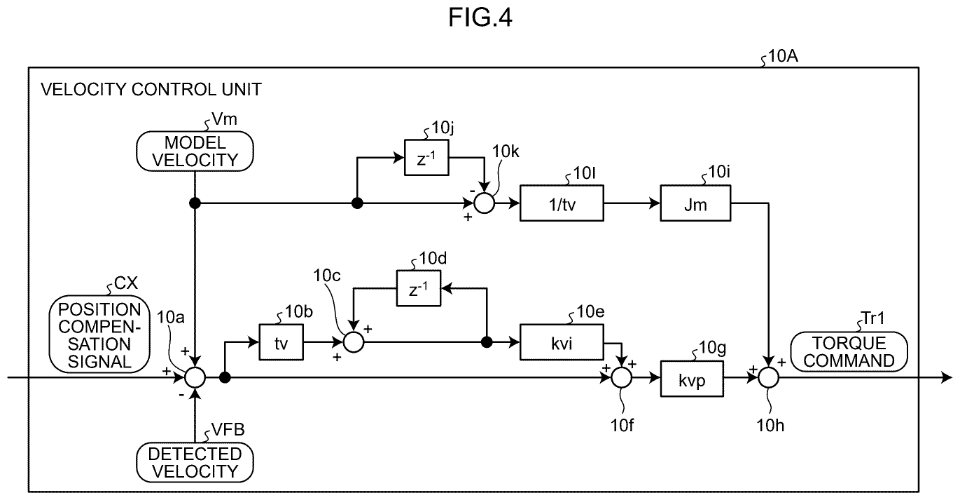

FIG. 4 is a block diagram illustrating a configuration of the velocity control unit included in the motor controller according to the first embodiment. The velocity control unit 10A includes arithmetic units 10a, 10c, 10f, 10h, and 10k, gains 10b and 10l, delay units 10d and 10j, a velocity integral gain 10e, a velocity proportional gain 10g, and an acceleration gain 10i.

In the velocity control unit 10A, the arithmetic unit 10a, the delay unit 10j, and the arithmetic unit 10k receive the model velocity Vm from the reference model unit 5A in both the position control interval Ps and the velocity control interval Vs. The arithmetic unit 10a receives the detected velocity VFB from the velocity detection unit 11 in both the position control interval Ps and the velocity control interval Vs. The arithmetic unit 10a receives the position compensation signal CX from the position control unit 6 in the position control interval Ps.

In the position control interval Ps, the arithmetic unit 10a subtracts the detected velocity VFB from the sum of the position compensation signal CX and the model velocity Vm. In the velocity control interval Vs, the arithmetic unit 10a subtracts the detected velocity VFB from the model velocity Vm. The arithmetic unit 10a outputs the calculation result to the gain 10b and the arithmetic unit 10f.

The gain 10b multiplies the output of the arithmetic unit 10a by tv and outputs the result to the arithmetic unit 10c. tv is the operation period of the velocity control unit 10A. The arithmetic unit 10c adds the output of the delay unit 10d to the output of the gain 10b, and outputs the addition result to the delay unit 10d and the velocity integral gain 10e.

The delay unit 10d receives the output from the arithmetic unit 10c, delays the output of the arithmetic unit 10c by one sample, and outputs the delayed output to the arithmetic unit 10c. Consequently, the arithmetic unit 10c adds the latest output value of the gain 10b to the output value of the arithmetic unit 10c one period ago, and outputs the addition result to the delay unit 10d and the velocity integral gain 10e.

The velocity integral gain 10e multiplies the output of the arithmetic unit 10c by kvi and outputs the result to the arithmetic unit 10f. kvi is the integral gain (integral strength). The arithmetic unit 10f adds the output of the arithmetic unit 10a to the output of the velocity integral gain 10e and outputs the result to the velocity proportional gain 10g.

The velocity proportional gain 10g multiplies the output of the arithmetic unit 10f by kvp and outputs the result to the arithmetic unit 10h. kvp is the proportional gain. Here, the output of the velocity proportional gain 10g is referred to as a velocity compensation signal CV. The arithmetic unit 10h calculates the sum of the output of the velocity proportional gain 10g and the output of the acceleration gain 10i, and outputs the calculation result to the drive device 14. The output of the arithmetic unit 10h is the torque command Tr1.

In the velocity control unit 10A, the processing performed by the gain 10b, the arithmetic unit 10c, and the delay unit 10d is integration processing. The velocity control unit 10A performs integral control with the gain 10b, the arithmetic unit 10c, the delay unit 10d, and the velocity integral gain 10e.

The velocity control unit 10A performs proportional control with the arithmetic units 10a and 10f and the velocity proportional gain 10g. Thus, the velocity control unit 10A performs proportional integral (PI) control with the arithmetic units 10a, 10c, and 10f, the gain 10b, the delay unit 10d, the velocity integral gain 10e, and the velocity proportional gain 10g.

The delay unit 10j delays the model velocity Vm by one sample and outputs the delayed model velocity Vm to the arithmetic unit 10k. The arithmetic unit 10k calculates the difference between the model velocity Vm and the output of the delay unit 10j, and outputs the calculation result to the gain 10l.

The gain 10l multiplies the output of the arithmetic unit 10k by 1/tv and outputs the result to the acceleration gain 10i. The processing performed by the delay unit 10j, the arithmetic unit 10k, and the gain 10l corresponds to processing to differentiate the model velocity Vm for conversion into a signal with the dimension of acceleration (differentiation processing). Thus, the signal output from the gain 10l corresponds to the acceleration of the object 7.

The acceleration gain 10i multiplies the output of the gain 10l by Jm and outputs the result to the arithmetic unit 10h. Jm corresponds to the load (mass) of the object 7. Thus, the acceleration gain 10i converts the signal output from the gain 10l into the dimension of force by multiplying the acceleration by the load. The value output from the acceleration gain 10i corresponds to the torque when the object 7 under control is regarded as a rigid body. Here, the output of the acceleration gain 10i is referred to as a model torque Tm (not illustrated).

As described above, the velocity control unit 10A determines the torque command Tr1 based on the sum of the velocity compensation signal CV calculated by the PI control and the model torque Tm. That is, the arithmetic unit 10h calculates the torque command Tr1 by adding a feedforward value that is the output value from the acceleration gain 10i and a feedback value that is the output value from the velocity proportional gain 10g.

Here, the model torque Tm is determined by multiplying the value obtained by differentiating the model velocity Vm by Jm with the acceleration gain 10i. That is, the model torque Tm is determined by modeling the object 7 as a rigid body, and represents an ideal torque necessary to drive the object 7. Therefore, the velocity compensation signal CV acts to compensate for a disturbance or a modeling error. Thus, the velocity control unit 10A can control the object 7 with high accuracy by controlling the object 7 based on the model torque Tm and the velocity compensation signal CV.

### <Reference Model Unit 5A>

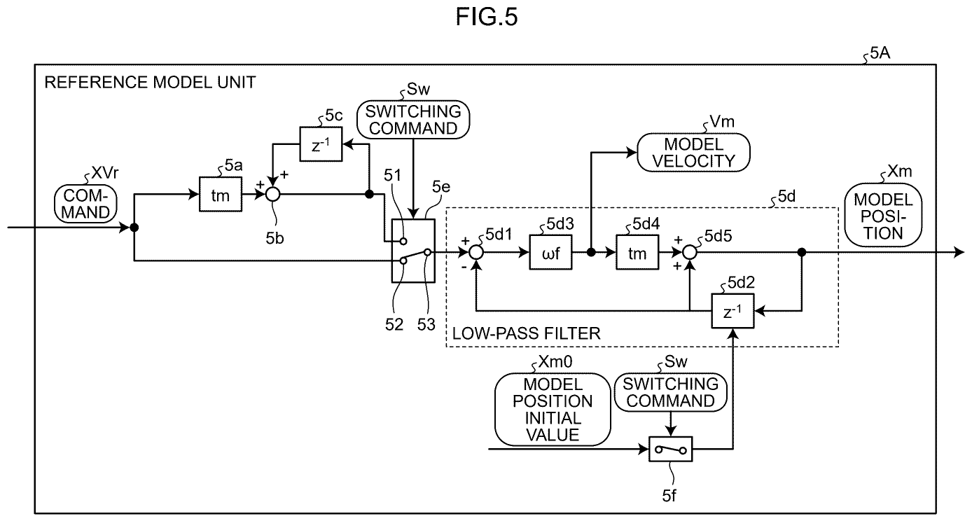

FIG. 5 is a block diagram illustrating a configuration of the reference model unit included in the motor controller according to the first embodiment. The reference model unit 5A includes a gain 5a, an arithmetic unit 5b, a delay unit 5c, the low-pass filter 5d, and switches 5e and 5f.

The command XVr sent from the switch 4 is input to the gain 5a and the switch 5e. The gain 5a multiplies the command XVr by tm and outputs the result to the arithmetic unit 5b. tm is the operation period of the reference model unit 5A. The arithmetic unit 5b adds the output of the delay unit 5c to the output of the gain 5a and outputs the result to the switch 5e. The delay unit 5c delays the output of the arithmetic unit 5b by one sample and outputs the delayed output to the gain 5a. The processing performed by the gain 5a, the arithmetic unit 5b, and the delay unit 5c is integration operation processing.

The switch 5e includes terminals 51 to 53. The terminal 51 is connected to the arithmetic unit 5b, and the terminal 52 is connected to the terminal 43 of the switch 4 (not illustrated in FIG. 5). The terminal 53 is connected to the low-pass filter 5d.

The switch 5e switches the connection destination of the terminal 53 to the terminal 51 or the terminal 52, based on the switching command Sw sent from the switching command unit 3. The switch 5e connects the terminal 53 to the terminal 51 in the velocity control interval Vs in which the velocity control is performed, and connects the terminal 53 to the terminal 52 in the position control interval Ps in which the position control is performed.

In the velocity control interval Vs, the velocity command Vr is input to the gain 5a as the command XVr. The command XVr is converted into a position command signal by the gain 5a, the arithmetic unit 5b, and the delay unit 5c, and input to the switch 5e. In the position control interval Ps, the position command Xr is input to the switch 5e as the command XVr. The switch 5e sends the signal corresponding to the velocity command Vr to the low-pass filter 5d in the velocity control interval Vs, and sends the position command Xr to the low-pass filter 5d in the position control interval Ps.

The low-pass filter 5d is a low-pass filter in which the reference model time constant T is a time constant of 1/ωf. The reference model unit 5A filters the position command Xr indicated by the command XVr using the low-pass filter 5d, to determine the model position Xm indicating a position corresponding to the filtered position command Xr. The low-pass filter 5d includes arithmetic units 5d1 and 5d5, a delay unit 5d2, and gains 5d3 and 5d4.

The arithmetic unit 5d1 calculates the difference between the output of the switch 5e and the output of the delay unit 5d2, and outputs the calculation result to the gain 5d3. The gain 5d3 is a gain to multiply the output of the arithmetic unit 5d1 by of. The gain 5d3 outputs the calculation result as the model velocity Vm to the velocity control unit 10A and the gain 5d4.

The gain 5d4 multiplies the model velocity Vm by tm and outputs the result to the arithmetic unit 5d5. The arithmetic unit 5d5 adds the output of the delay unit 5d2 to the output of the gain 5d4. The arithmetic unit 5d5 outputs the calculation result to the position control unit 6 as the model position Xm. The processing performed by the arithmetic unit 5d5, the delay unit 5d2, and the gain 5d4 is integration operation processing.

As described above, the reference model unit 5A calculates the model velocity Vm, using the signal obtained by integrating the velocity command Vr as an input to the low-pass filter 5d during the velocity control, and calculates the model position Xm and the model velocity Vm using the position command Xr as an input to the low-pass filter 5d during the position control. The reference model unit 5A calculates the model position Xm also during the velocity control. However, the switch 9 is turned off during the velocity control, so that control using the model position Xm is not performed.

Here, the position command generation unit 2 determines the position command Xr with a method described below, to match a command velocity corresponding to a signal obtained by differentiating the position command Xr at the switching time ts with respect to time (command velocity Vrx described below) to the velocity command Vr at the switching time ts. Further, the model velocity Vm in the velocity control interval Vs is determined by inputting a signal obtained by integrating the velocity command Vr to the low-pass filter 5d, so that the model velocity Vm in the velocity control interval Vs matches the model velocity Vm in the position control interval Ps. Therefore, at the time of switching from the velocity control to the position control, the model velocity Vm does not cause a sudden change anomaly in the operation of the object 7.

Further, the low-pass filter 5d has a low-pass filter characteristic of the time constant 1/ωf to remove high frequency components from the position command Xr and the velocity command Vr, so that the object 7 can be controlled with high accuracy. Furthermore, the motor controller 101 can adjust the responsiveness from the velocity command Vr to the velocity of the object 7 and the responsiveness from the position command Xr to the position of the object 7, using the time constant 1/ωf, so that the object 7 can be controlled with high accuracy.

The switch 5f is a switch that receives the switching command Sw from the switching command unit 3 and switches between on and off, based on the switching command Sw. The switch 5f is turned on with terminals connected at the switching time ts of switching from the velocity control to the position control, and is turned off at other times. That is, the switch 5f is turned on with the terminals connected at the switching time ts of switching from the velocity control to the position control, and is turned off at times other than the switching time ts. When the switch 5f is turned on, the model position initial value Xm0 is input to the delay unit 5d2, and the output value from the delay unit 5d2 is rewritten to the model position initial value Xm0. That is, the model position Xm(ts) at the switching time ts of switching from the velocity control to the position control can be expressed by formula (1) below.

$$\begin{matrix}Formula 1 & \\ Xm ( ts ) = Vm ( ts ) \cdot tm + Xm 0 & ( 1 )\end{matrix}$$

Here, Vm(ts) is the model velocity Vm at the switching time ts of switching to the position control. Thus, by rewriting the value of the delay unit 5d2, the reference model unit 5A can determine the model position Xm(ts) at the time of switching to the position control according to the model position initial value Xm0.

### <Model Initial Value Setting Unit 12>

The model initial value setting unit 12 sets the model position initial value Xm0 based on the detected position XFB, and outputs the model position initial value Xm0 to the reference model unit 5A. The model initial value setting unit 12 can match the model position Xm(ts) at the switching time ts to the detected position XFB(ts) by determining the model position initial value Xm0 as in formula (2) below from formula (1) above.

$$\begin{matrix}Formula 2 & \\ Xm 0 = XFB ( ts ) - Vm ( ts - tm ) \cdot tm & ( 2 )\end{matrix}$$

Here, Vm(ts−tm) is the model velocity Vm immediately before switching from the velocity control to the position control. That is, Vm(ts−tm) is the model velocity Vm one sample before the timing of switching from the velocity control to the position control. As described above, since the model velocities before and after the switching match, Vm(ts−tm)=Vm(ts). Thus, by determining the model position initial value Xm0 using formula (2), the model initial value setting unit 12 can match the model position Xm to the detected position XFB, and can make the position compensation signal CX at the switching time ts zero. Consequently, at the time of switching from the velocity control to the position control, the model position Xm does not cause a sudden change anomaly in the operation of the object 7.

If Vm(ts−tm)·tm, which is the second term on the right side of formula (2), is a sufficiently smaller value than XFB(ts), the model initial value setting unit 12 may determine the model position initial value Xm0 using formula (3) below.

$$\begin{matrix}Formula 3 & \\ Xm 0 = XFB ( ts ) & ( 3 )\end{matrix}$$

The model velocity Vm is referred to in formula (2) to determine the model position initial value Xm0. Alternatively, the detected velocity VFB or the velocity command Vr at the switching time ts may be referred to in formula (2). That is, the model initial value setting unit 12 may determine the model position initial value Xm0 using formula (2) that refers to the detected velocity VFB or the velocity command Vr at the switching time ts. In other words, the model initial value setting unit 12 may determine the model position initial value Xm0 using formula (2) to which the detected velocity VFB or the velocity command Vr at the switching time ts is applied instead of the model velocity Vm.

### <Position Command Generation Unit 2>

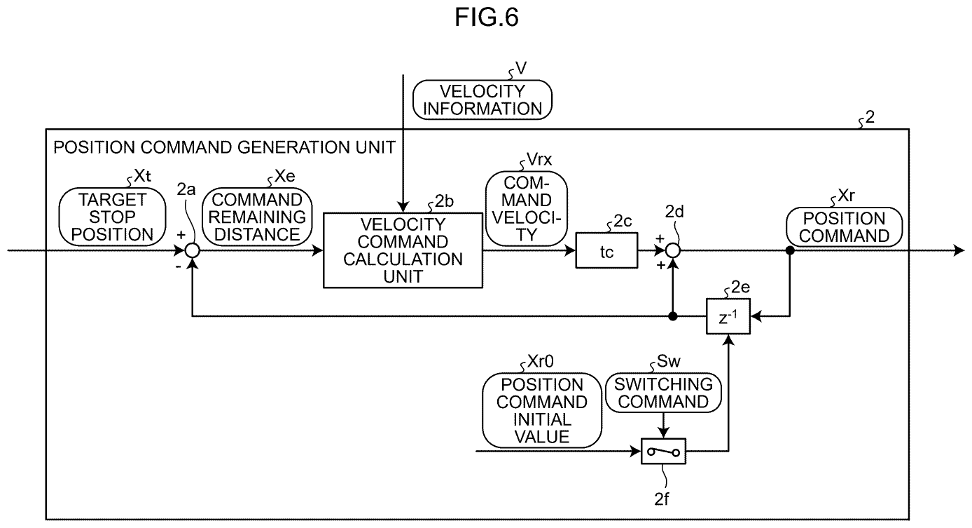

FIG. 6 is a block diagram illustrating a configuration of the position command generation unit included in the motor controller according to the first embodiment. The position command generation unit 2 includes an arithmetic unit 2a, a velocity command calculation unit 2b, a gain 2c, an arithmetic unit 2d, a delay unit 2e, and a switch 2f.

The target stop position Xt acquired from the control program is input to the arithmetic unit 2a. The arithmetic unit 2a calculates a command remaining distance Xe that is the difference between the target stop position Xt and the output of the delay unit 2e. The command remaining distance Xe is a signal indicating a remaining distance to the target stop position Xt in the case where the object 7 is moved to the target stop position Xt. The arithmetic unit 2a sends the command remaining distance Xe, which is the calculation result, to the velocity command calculation unit 2b.

The velocity command calculation unit 2b generates the command velocity Vrx based on the command remaining distance Xe. The command velocity Vrx corresponds to the derivative value of the position command Xr used during the position control. That is, the command velocity Vrx is a signal that is integrated with respect to time after this to become the position command Xr. In other words, the position command Xr corresponds to a signal obtained by integrating the command velocity Vrx.

The velocity command calculation unit 2b receives the model velocity Vm, the velocity command Vr, or the detected velocity VFB as the velocity information V. Here, a description is given of a case where the velocity command calculation unit 2b receives the velocity command Vr as the velocity information V. The velocity command calculation unit 2b receives a velocity command initial value that is the velocity command Vr at the time of switching from the velocity control to the position control from the velocity command generation unit 1. In the first embodiment, the velocity command calculation unit 2b determines the command velocity Vrx using formulas (4) and (5) below.

$$\begin{matrix}Formula 4 & \\ Vrx = \sqrt{2 aXe} ( when \sqrt{2 aXe} \leq Vc ) ↵ & ( 4 )\end{matrix}$$

$$\begin{matrix}Formula 5 & \\ Vrx = Vc ( when \sqrt{2 aXe} > Vc ) ↵ & ( 5 )\end{matrix}$$

Here, a is deceleration, and Vc is the value of the velocity command Vr in the constant velocity interval (interval from time t1 to time t2 in FIG. 2). The velocity command calculation unit 2b can match the velocity command Vr (velocity command initial value) at the time of switching from the velocity control to the position control to the command velocity Vrx at the time of switching by determining the command velocity Vrx(=Vc) using formula (5). That is, the velocity command calculation unit 2b can match the velocity of the object 7 during the velocity control to the time derivative value (slope) of the position command.

Further, by determining the command velocity Vrx using formula (4), the velocity command calculation unit 2b can decelerate the object 7 at a specified deceleration, and can determine the command velocity Vrx to stop the object 7 at the target stop position Xt. The velocity command calculation unit 2b outputs the command velocity Vrx, which is the calculation result, to the gain 2c. Note that the velocity command calculation unit 2b may match the command velocity Vrx at the time of switching from the velocity control to the position control to the model velocity Vm or the detected velocity VFB.

The gain 2c multiplies the command velocity Vrx by tc and outputs the result to the arithmetic unit 2d. tc is the operation period of the position command generation unit 2. The arithmetic unit 2d adds the output of the delay unit 2e to the output of the gain 2c to calculate the position command Xr, and outputs the calculation result to the delay unit 2e and the switch 4.

The delay unit 2e delays the output of the arithmetic unit 2d by one sample and outputs the delayed output to the arithmetic unit 2d and the arithmetic unit 2a. Consequently, the arithmetic unit 2d adds the latest output value of the gain 2c to the output value of the arithmetic unit 2d one period ago. Then, the arithmetic unit 2d outputs the calculated position command Xr to the delay unit 2e and the switch 4.

The processing performed by the gain 2c, the arithmetic unit 2d, and the delay unit 2e is integration operation processing. Thus, the position command generation unit 2 can determine the position command Xr corresponding to the command velocity Vrx by integrating the command velocity Vrx to determine the position command Xr.

The switch 2f is a switch that receives the switching command Sw from the switching command unit 3 to switch between on and off, based on the switching command Sw. The switch 2f is turned on with terminals connected at the switching time ts of switching from the velocity control to the position control, and is turned off at other times. That is, the switch 2f is turned on with the terminals connected at the switching time ts of switching from the velocity control to the position control, and is turned off at times other than the switching time ts. When the switch 2f is turned on, the position command initial value Xr0 is input to the delay unit 2e, and the output value from the delay unit 2e is rewritten to the position command initial value Xr0. That is, the position command Xr(ts) at the switching time ts of switching from the velocity control to the position control can be expressed by formula (6) below.

$$\begin{matrix}Formula 6 & \\ Xr ( ts ) = Vrx ( ts ) \cdot ts + Xr 0 & ( 6 )\end{matrix}$$

Here, Vrx(ts) is the command velocity Vrx at the switching time ts of switching to the position control. Thus, by rewriting the value of the delay unit 2e, the position command generation unit 2 can determine the position command Xr(ts) at the time of switching to the position control according to the position command initial value Xr0.

### <Position Command Initial Value Setting Unit 13>

First, the relationship between the position command Xr and the model position Xm will be described. In the position control interval Ps, the model position Xm is set using formula (7) below. That is, the reference model unit 5A calculates the model position Xm from the position command Xr using formula (7) below.

$$\begin{matrix}Formula 7 & \\ Xm ( s ) = ω f / ( ω f + s ) Xr ( s ) & ( 7 )\end{matrix}$$

Here, s is the Laplace operator, Xm(s) is the Laplace transform of the model position Xm, and Xr(s) is the Laplace transform of the position command Xr. The portion of ωf/(ωf+s) in formula (7) corresponds to the continuous system of the low-pass filter 5d. The portion of Xr(s) in formula (7) is the input position command Xr.

The Laplace transform Vm(s) of the model velocity Vm and the Laplace transform Xm(s) of the model position Xm have the relationship of formula (8) below. The relationship of formula (9) below can be obtained from formula (7).

$$\begin{matrix}Formula 8 & \\ Xm ( s ) = Vm ( s ) / s & ( 8 )\end{matrix}$$

$$\begin{matrix}Formula 9 & \\ Xr ( s ) - Xm ( s ) = ( ω f + s ) / ω f Xm ( s ) - Xm ( s ) & ( 9 )\end{matrix}$$

On the right side of formula (8), the Laplace transform Vm(s) is multiplied by 1/s to integrate the Laplace transform Vm(s). Formula (8) indicates that the integrated Laplace transform Vm(s) is equal to the Laplace transform Xm(s). When formula (9) is transformed using formula (8) for the inverse Laplace transform, and further, the influence of discretization is taken into consideration, formula (10) below can be obtained as the relationship between the position command Xr(t) and the model position Xm(t).

$$\begin{matrix}Formula 10 & \\ Xr ( t ) = Xm ( t ) + Vm ( t ) / ω f - Vm ( t ) tm & ( 10 )\end{matrix}$$

In formula (10), Vm(t)/ωf is the amount of delay of the model position due to the low-pass filter 5d, and −Vm(t)tm is the amount of delay of the model position due to the influence of discretization. Here, Xr(t) and Xm(t) are the position command and the model position at time t, respectively. That is, formula (10) shows that the model position Xm is delayed by Vm(t)/ωf−Vm(t) tm with respect to the position command Xr. Therefore, by taking into consideration the matching of the model position Xm to the detected position XFB at the switching time ts, the position command Xr and the model position Xm satisfy the relationship of formula (10) when the position command initial value Xr0 is determined with formula (11) below.

$$\begin{matrix}Formula 11 & \\ Xr 0 = XFB ( ts ) + Vm ( ts - tm ) / ω f - Vrx ( ts - tc ) tc - Vm ( ts - tm ) tm & ( 11 )\end{matrix}$$

The portion of Vrx(ts−tc) tc in formula (11) corresponds to the position command Xr one sample ago. Thus, the position command Xr one sample ago to be added by the arithmetic unit 2d is subtracted from the output of the gain 2c, so that this subtraction and the addition by the arithmetic unit 2d are canceled out.

The position command initial value setting unit 13 determines the position command initial value Xr0 using formula (11). That is, the position command initial value setting unit 13 determines the position command initial value Xr0 based on the detected position XFB at the switching time ts, the model velocity Vm at the switching time ts, and the time constant 1/ωf of the low-pass filter 5d. Specifically, the position command initial value setting unit 13 determines the position command initial value Xr0 such that the position command at the switching time ts matches the sum of the detected position XFB at the switching time ts and the multiplication result of multiplying the model velocity Vm at the switching time ts by the time constant 1/ωf of the low-pass filter 5d. This allows the position command Xr and the model position Xm to satisfy the relationship of formula (10). Consequently, at the time of switching from the velocity control to the position control, the position command Xr does not cause a sudden change anomaly in the operation of the object 7.

If Vrx(ts) tc and Vm(ts−tm) tm are sufficiently smaller than XFB(ts−tm)+Vm(ts)/ωF, the position command initial value setting unit 13 may determine the position command initial value Xr0 with formula (12) below.

$$\begin{matrix}Formula 12 & \\ Xr 0 = XFB ( ts ) + Vm ( ts ) / ω f & ( 12 )\end{matrix}$$

Here, the position command initial value Xr0 is determined based on the model velocity Vm in formulas (11) and (12). However, the velocity command Vr or the detected velocity VFB may be used instead of the model velocity Vm. That is, the position command initial value setting unit 13 may determine the position command initial value Xr0 with formula (12) using the velocity command Vr or the detected velocity VFB instead of the model velocity Vm.

Alternatively, the position command initial value setting unit 13 may determine the position command initial value Xr0, using two or more of the model velocity Vm, the velocity command Vr, and the detected velocity VFB. Thus, the position command initial value setting unit 13 determines the position command initial value Xr0, using at least one of the model velocity Vm, the velocity command Vr, and the detected velocity VFB. When the position command initial value setting unit 13 uses two or more of the model velocity Vm, the velocity command Vr, and the detected velocity VFB, the position command initial value setting unit 13 determines the position command initial value Xr0 using, for example, the mean value of at least two of the model velocity Vm, the velocity command Vr, and the detected velocity VFB, or the like.

In formulas (11) and (12), the delay of the model position Xm with respect to the position command Xr is determined based on the model velocity Vm and the time constant 1/ωf. However, as is clear from formula (9), the position command initial value setting unit 13 can also determine the delay of the model position Xm with respect to the position command Xr, using the difference between the position command Xr and the model position Xm. Since the output of the arithmetic unit 5b, which is a signal obtained by integrating the velocity command Vr, corresponds to the position command Xr, the position command initial value setting unit 13 may determine the position command initial value Xr0 using formula (13) below.

$$\begin{matrix}Formula 13 & \\ Xr 0 = XFB ( ts ) + Xme ( ts - tm ) & ( 13 )\end{matrix}$$

Here, Xme(ts−tm) is the output of the arithmetic unit 5d1 at time (ts−tm), and corresponds to the delay of the model position Xm with respect to the position command Xr. Xme(ts−tm) is a model position deviation indicating the difference between the time integral value of the model velocity Vm and the time integral value of the velocity command Vr. That is, Xme(ts−tm) corresponds to the time integral value of the difference between the model velocity Vm and the velocity command Vr.

Time integration processing of the velocity command Vr corresponds to processing in which the gain 5a, the arithmetic unit 5b, and the delay unit 5c perform an integration operation on the velocity command Vr during the velocity control. Therefore, the time integral value of the velocity command Vr corresponds to the value input from the switch 5e to the arithmetic unit 5d1 during the velocity control.

Time integration processing of the model velocity Vm corresponds to processing in which the arithmetic unit 5d5, the delay unit 5d2, and the gain 5d4 perform an integration operation on the model velocity Vm during the velocity control. Therefore, the time integral value of the model velocity Vm corresponds to the value input from the delay unit 5d2 to the arithmetic unit 5d1 during the velocity control.

Processing to calculate the difference between the time integral value of the model velocity Vm and the time integral value of the velocity command Vr corresponds to processing in which the arithmetic unit 5d1 calculates the difference between the output value from the switch 5e and the output value from the delay unit 5d2. Therefore, by receiving the output value (model position deviation) output from the arithmetic unit 5d1, the position command initial value setting unit 13 can set the position command initial value Xr0 using formula (13). Thus, the position command initial value setting unit 13 determines the position command initial value Xr0 used to calculate the model position Xm at the time of switching such that the position command initial value Xr0 matches the sum of the detected position XFB(ts) and the model position deviation Xme(ts−tm).

In the above-described example, the low-pass filter 5d is a first-order low-pass filter. Alternatively, the low-pass filter 5d may be an nth-order (n≥2) low-pass filter as expressed by formula (14) below.

$$\begin{matrix}Formula 14 & \\ {G}_{LPF} ( s ) = \frac{1}{1 + \frac{1}{{a}_{1}} s + \frac{1}{{a}_{2}} {s}^{2} + … + \frac{1}{{a}_{n}} {s}^{n}} & ( 14 )\end{matrix}$$

Here, 1/a₁ to 1/aₙ are time constants. The reference model unit 5A can calculate the model position Xm by inputting the position command Xr to the low-pass filter expressed by formula (14).

When the transfer function of the low-pass filter 5d is expressed by formula (13), the position command initial value setting unit 13 can determine the position command initial value Xr0 based on formula (12) with the time constant set to 1/a₁.

With this configuration, even when the position command Xr is filtered (by the low-pass filter 5d etc.), the motor controller 101 can prevent a sudden change in the operation of the object 7 at the time of switching from the velocity control to the position control.

The model position Xm, the position command Xr, and the detected position XFB may be signals related to the position of the motor, or signals related to the position of the mobile object. The model velocity Vm, the velocity command Vr, and the detected velocity VFB may be signals related to the velocity of the motor, or signals related to the velocity of the mobile object.

When filtering is performed on the position command Xr, the actual position of the object 7 with respect to the position command Xr is delayed. In this case, if the position command Xr at the time of switching from the non-position control such as the velocity control to the position control is matched to the detected position XFB of the object 7 at the time of switching without taking the filtering into consideration, the filtering causes a delay in the signal, so that the mechanical operation suddenly changes at the time of switching to the position control, and the positioning accuracy deteriorates.

By contrast, in the motor controller 101 of the first embodiment, the position command initial value setting unit 13 determines the position command initial value Xr0 based on the detected position XFB and the model velocity Vm at the switching time ts, and the time constant 1/ωf of the low-pass filter 5d. Therefore, even when the filtering causes a delay in the signal, the mechanical operation does not change suddenly at the time of switching to the position control, and the positioning accuracy does not deteriorate.

As described above, in the motor controller 101 of the first embodiment, the position command initial value setting unit 13 sets the position command initial value Xr0 based on the velocity information V of the object 7 at the time of switching (switching time ts), the detected position XFB at the time of switching, and the transfer characteristic as the characteristic of the transfer function (time constant 1/ωf) of the low-pass filter 5d to smooth the position command Xr. Then, the position command generation unit 2 generates the position command Xr at the time of switching, based on the position command initial value Xr0, and the position command Xr is passed through the low-pass filter 5d. Consequently, the motor controller 101 can smooth the position command Xr, and can adjust the position command Xr at the time of switching from the velocity control to the position control to a command according to the signal delay due to the time constant 1/ωf. Therefore, the motor controller 101 can prevent a sudden change in the mechanical operation while smoothing the position command Xr.

### Second Embodiment

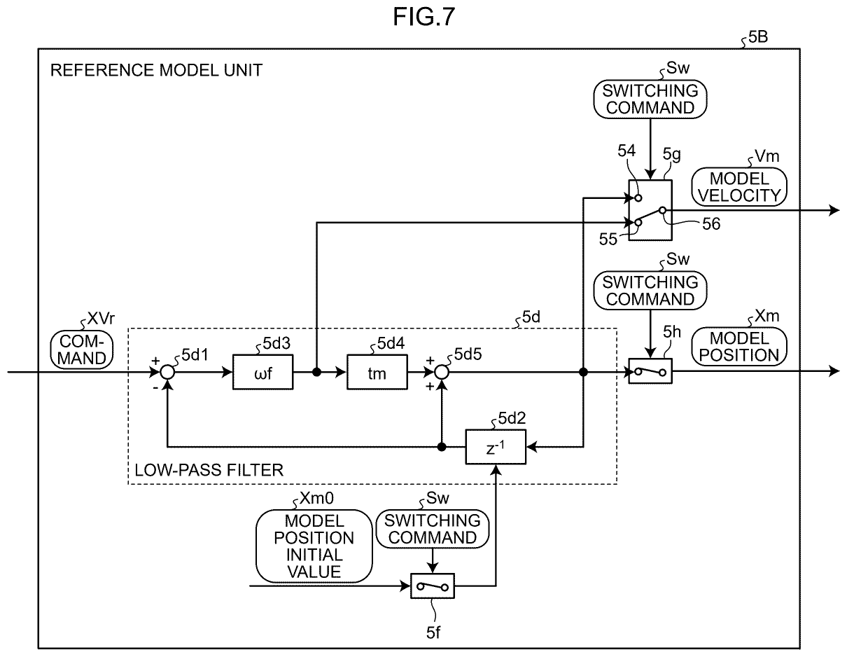

Next, the second embodiment will be described with reference to FIG. 7. In the second embodiment, during the velocity control, the velocity command Vr is input to a reference model unit without being integrated, and the model velocity Vm output from the arithmetic unit 5d5 is output to the velocity control unit 10A.

The motor controller 101 of the second embodiment is different from the motor controller 101 of the first embodiment only in the configuration of the reference model unit, and the other configuration is the same.

FIG. 7 is a block diagram illustrating a configuration of the reference model unit included in the motor controller according to the second embodiment. Of the components in FIG. 7, components that achieve the same functions as those of the reference model unit 5A of the first embodiment illustrated in FIG. 5 are denoted by the same reference numerals, and redundant descriptions thereof will be omitted.

A reference model unit 5B of the second embodiment does not include the gain 5a, the arithmetic unit 5b, the delay unit 5c, and the switch 5e as compared with the reference model unit 5A of the first embodiment. The reference model unit 5B includes switches 5g and 5h as compared with the reference model unit 5A. That is, the reference model unit 5B includes the low-pass filter 5d and the switches 5f, 5g, and 5h.

The switch 5g includes terminals 54 to 56. The terminal 54 is connected to the arithmetic unit 5d5, and the terminal 55 is connected to the gain 5d3. The terminal 56 is connected to the velocity control unit 10A.

The switch 5g switches the connection destination of the terminal 56 to the terminal 54 or the terminal 55, based on the switching command Sw sent from the switching command unit 3. The switch 5g connects the terminal 56 to the terminal 54 in the velocity control interval Vs in which the velocity control is performed, and connects the terminal 56 to the terminal 55 in the position control interval Ps in which the position control is performed.

The switch 5h is a switch that is turned on in the position control interval Ps and is turned off in the velocity control interval Vs, based on the switching command Sw sent from the switching command unit 3. The switch 5h is turned on to output the model position Xm to the position control unit 6, and is turned off to interrupt the output of the model position Xm to the position control unit 6.

In the velocity control interval Vs, the velocity command Vr is input to the arithmetic unit 5d1 as the command XVr, and the model velocity Vm is output from the arithmetic unit 5d5. In the velocity control interval Vs, the switch 5g connects the terminal 56 to the terminal 54, and the switch 5h is turned off. Consequently, in the velocity control interval Vs, the model velocity Vm output from the arithmetic unit 5d5 is output to the velocity control unit 10A via the switch 5g. No signal is sent from the switch 5h to the position control unit 6.

On the other hand, in the position control interval Ps, the position command Xr is input to the arithmetic unit 5d1 as the command XVr, and the model position Xm is output from the arithmetic unit 5d5. In the position control interval Ps, the switch 5g connects the terminal 56 to the terminal 55, and the switch 5h is turned on. Consequently, in the position control interval Ps, the model velocity Vm output from the gain 5d3 is output to the velocity control unit 10A via the switch 5g. The model position Xm is output from the switch 5h to the position control unit 6.

Thus, when receiving the velocity command Vr as the command XVr in the velocity control interval Vs, the reference model unit 5B outputs the model velocity Vm from the switch 5g. When receiving the position command Xr as the command XVr in the position control interval Ps, the reference model unit 5B outputs the model velocity Vm from the switch 5g and outputs the model position Xm from the switch 5h.

Differences between the operation of the reference model unit 5B and the operation of the reference model unit 5A are the following differences D1 to D4. The differences D1 to D4 are in the operation during the velocity control. The operation during the position control is the same between the first and second embodiments.
(D1) The reference model unit 5B of the second embodiment inputs the velocity command Vr directly to the low-pass filter 5d without integration during the velocity control.
(D2) In the reference model unit 5B of the second embodiment, during the velocity control, the output of the arithmetic unit 5d5 is the model velocity Vm, and the arithmetic unit 5d5 outputs the model velocity Vm to the velocity control unit 10A.
(D3) In the reference model unit 5B of the second embodiment, the gain 5d3 does not output the model velocity Vm to the velocity control unit 10A during the velocity control.
(D4) The reference model unit 5B of the second embodiment does not output the model position Xm to the position control unit 6 during the velocity control (which is equivalent to outputting the model position as zero).

In the second embodiment, the motor controller 101 may not include the switch 9. In this case, the motor controller 101 of the second embodiment may not include the switch 5h.

As described above, the motor controller 101 of the second embodiment eliminates the need for an operation to integrate the velocity command Vr, and thus reduces the operation cost. In a case where the object 7 is conveyed for a long distance, if the velocity command Vr is integrated, the integration operation result can become very large and overflow. The motor controller 101 eliminates the need to integrate the velocity command Vr and thus can prevent overflow.

### Third Embodiment

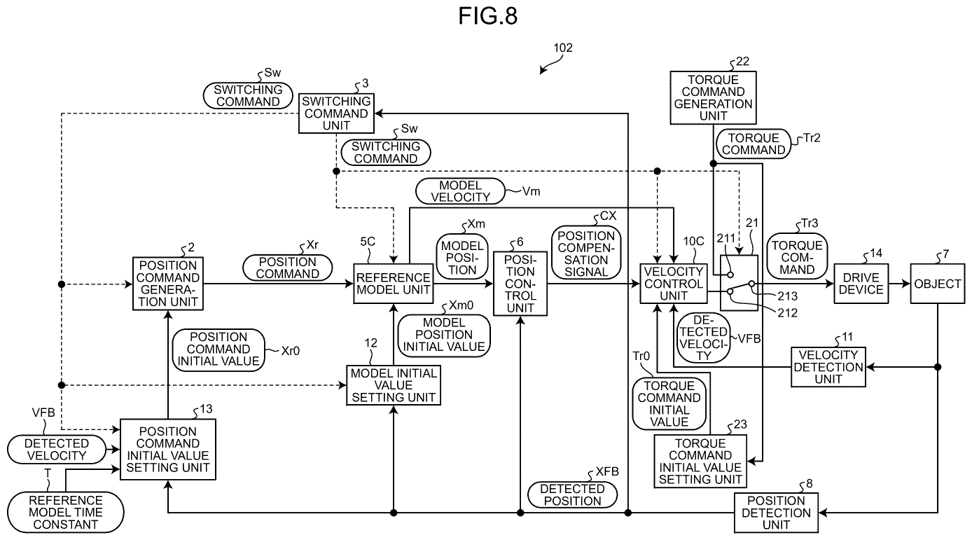

Next, the third embodiment will be described with reference to FIGS. 8 to 10. In the third embodiment, a motor controller switches from torque control to position control.

FIG. 8 is a block diagram illustrating a configuration of the motor controller according to the third embodiment. Of the components in FIG. 8, components that achieve the same functions as those of the motor controller 101 of the first embodiment illustrated in FIG. 1 are denoted by the same reference numerals, and redundant descriptions thereof will be omitted.

A motor controller 102 of the third embodiment includes a torque command generation unit 22, a torque command initial value setting unit 23, and a switch 21 in addition to the components included in the motor controller 101 of the first embodiment. The motor controller 102 does not include the velocity command generation unit 1, the switch 4, and the switch 9. The motor controller 102 includes a reference model unit 5C instead of the reference model unit 5A, and a velocity control unit 10C instead of the velocity control unit 10A. In the third embodiment, a system including the motor controller 102, the drive device 14, and the object 7 is a motor control system.

In the third embodiment, the torque command Tr1 calculated and output in the position control interval Ps by the velocity control unit 10C is a first torque command, and a torque command Tr2 generated and output in a torque control interval by the torque command generation unit 22 is a second torque command.

Hereinafter, differences between processing performed in the third embodiment and the processing performed in the first or second embodiment will be mainly described. The torque command generation unit 22 is connected to the torque command initial value setting unit 23 and the switch 21. The torque command initial value setting unit 23 is connected to the velocity control unit 10C, and the velocity control unit 10C is connected to the switch 21.

The torque command generation unit 22 outputs, to the switch 21, the torque command Tr2 that is a torque command to operate the object 7 with a specific torque in the torque control interval that is a period in which the torque control is performed. The torque command Tr2 is output to the drive device 14 as a torque command Tr3 in the torque control interval. The torque command generation unit 22 also outputs the torque command Tr2 to the torque command initial value setting unit 23. In the third embodiment, the torque command generation unit 22 is the non-position command generation unit. In the third embodiment, the torque command Tr2 generated by the torque command generation unit 22 is the non-position command.

The switching command unit 3 of the third embodiment outputs “0” as the switching command Sw in the torque control interval. When the switching command Sw is “0”, the object 7 is driven under the torque control. The switching command unit 3 of the third embodiment outputs “1” as the switching command Sw in the position control interval Ps. When the switching command Sw is “1”, the object 7 is driven under the position control. The switching command unit 3 sends the switching command Sw to the position command generation unit 2, the reference model unit 5C, the velocity control unit 10C, the model initial value setting unit 12, the position command initial value setting unit 13, and the switch 21.

The switch 21 includes terminals 211 to 213. The terminal 211 is connected to the torque command generation unit 22, and the terminal 212 is connected to the velocity control unit 10C. The terminal 213 is connected to the drive device 14.

The switch 21 switches the connection destination of the terminal 213 to the terminal 211 or the terminal 212, based on the switching command Sw sent from the switching command unit 3. The switch 21 connects the terminal 213 to the terminal 211 in the torque control interval, and connects the terminal 213 to the terminal 212 in the position control interval Ps. The output of the switch 21 is the torque command Tr3. That is, the switch 21 outputs the torque command Tr2 sent from the torque command generation unit 22 as the torque command Tr3 in the torque control interval, and outputs the torque command Tr1 sent from the velocity control unit 10C as the torque command Tr3 in the position control interval Ps. The switch 21 outputs the torque command Tr3 to the drive device 14.

A signal related to the velocity, used by the motor controller 102 of the third embodiment is only the detected velocity VFB, and the motor controller 102 does not use the velocity command Vr and the model velocity Vm. Thus, the position command generation unit 2 (velocity command calculation unit 2b) of the motor controller 102 of the third embodiment matches the command velocity Vrx to the detected velocity VFB. That is, the motor controller 101 of the first or second embodiment matches the command velocity to any one of the velocity command Vr, the model velocity Vm, and the detected velocity VFB, whereas the motor controller 102 of the third embodiment matches the command velocity to the detected velocity VFB.

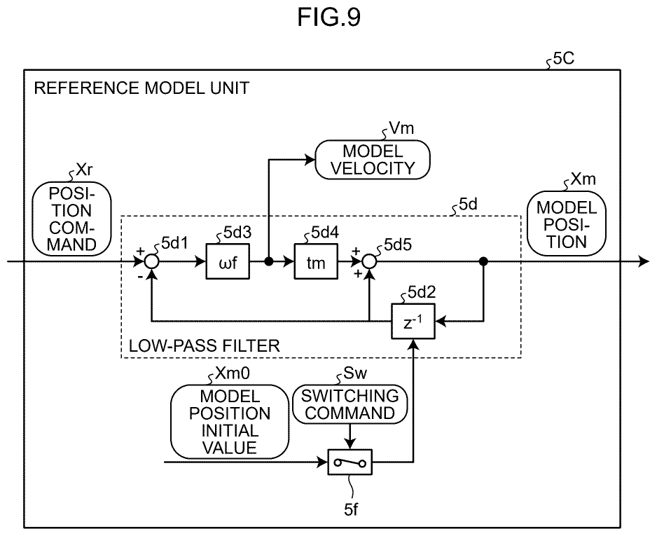

FIG. 9 is a block diagram illustrating a configuration of the reference model unit included in the motor controller according to the third embodiment. As compared with the reference model unit 5A of the first embodiment, the reference model unit 5C does not include the gain 5a, the arithmetic unit 5b, the delay unit 5c, and the switch 5e. That is, the reference model unit 5C includes the low-pass filter 5d and the switch 5f.

The position command Xr output from the position command generation unit 2 is input to the low-pass filter 5d of the reference model unit 5C. Thus, the reference model unit 5C of the third embodiment has the same function as the reference model unit 5A during the position control.

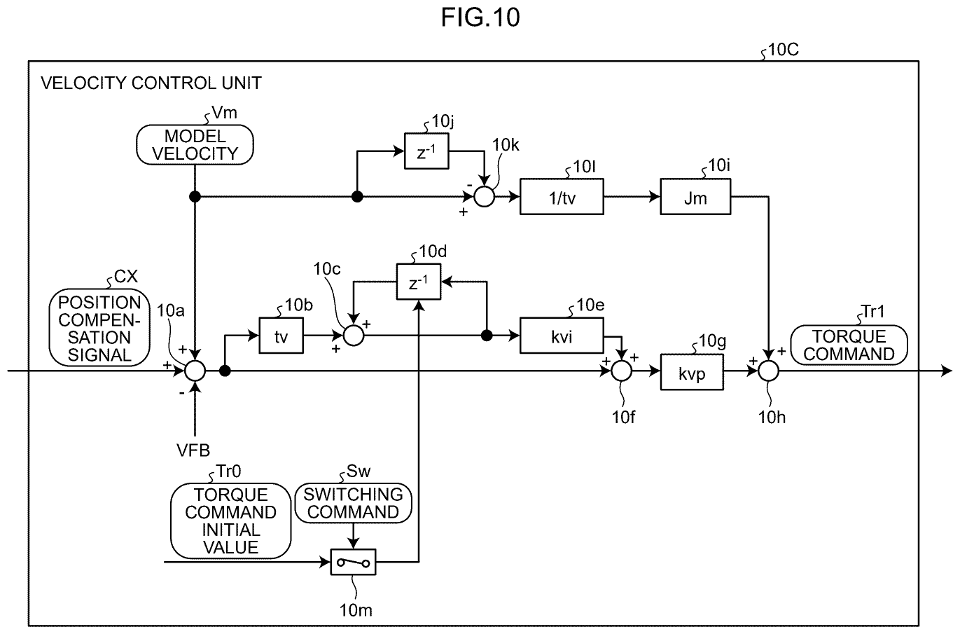

FIG. 10 is a block diagram illustrating a configuration of the velocity control unit included in the motor controller according to the third embodiment. The velocity control unit 10C includes a switch 10m in addition to the components included in the velocity control unit 10A of the first embodiment. The switch 10m is connected to the delay unit 10d.

The position compensation signal CX output from the position control unit 6 is input to the arithmetic unit 10a of the velocity control unit 10C. In the motor controller 102 of the third embodiment, the switch 9 is not disposed upstream of the velocity control unit 10C, and the position compensation signal CX calculated by the position control unit 6 is input to the arithmetic unit 10a without passing through the switch 9.

The switch 10m is a switch that receives the switching command Sw from the switching command unit 3 and switches between on and off, based on the switching command Sw. The switch 10m is turned on with terminals connected at the switching time ts of switching from the torque control to the position control, and is turned off at other times. That is, the switch 10m is turned on with the terminals connected at the switching time ts of switching from the torque control to the position control, and is turned off at times other than the switching time ts. When the switch 10m is turned on, the torque command initial value Tr0 is input to the delay unit 10d, and the output value from the delay unit 10d is rewritten to a torque command initial value Tr0. In a case where the object 7 is driven at a constant velocity immediately after switching from the torque control to the position control, the output of the acceleration gain 10i is zero.

Consequently, the torque command Tr2 during the torque control matches the torque command Tr1 during the position control before and after switching from the torque control to the position control, and thus the switching of the switch 21 does not cause a sudden change anomaly in the operation of the object 7.

Next, an operation of the motor controller 102 of the third embodiment will be described. Here, differences between the operation of the motor controller 102 of the third embodiment and the operation of the motor controller 101 of the first or second embodiment will be mainly described.

When receiving the switching command Sw from the switching command unit 3, the switch 10m is turned on with the terminals connected, and inputs the torque command initial value Tr0 to the delay unit 10d. Thus, the output value from the delay unit 10d is rewritten to the torque command initial value Tr0. As described in the first embodiment, at the switching time ts, the model velocity Vm matches the detected velocity VFB, and the model position Xm matches the detected position XFB, so that the position compensation signal CX=0. Consequently, the output of the arithmetic unit 10a is zero. As described above, the torque command Tr(ts) for the position control at the switching time ts can be expressed by formula (15) below.

$$\begin{matrix}Formula 15 & \\ Tr ( ts ) = Tr 0 \cdot kvi \cdot kvp & ( 15 )\end{matrix}$$

Thus, by rewriting the value of the delay unit 10d to the torque command initial value Tr0, the motor controller 102 can determine the torque command Tr(ts) for the position control at the switching time ts, according to the torque command initial value Tr0.

The torque command initial value setting unit 23 of the third embodiment determines the torque command initial value Tr0 based on the torque command Tr2 during the torque control. Specifically, the torque command initial value setting unit 23 determines the torque command initial value Tr0 such that the torque command Tr2 for the torque control matches the torque command Tr1 for the position control at the time of switching from the torque control to the position control. Since the torque command Tr(ts) for the position control at the switching time ts of switching from the torque control to the position control can be expressed by formula (15) above, the torque command initial value setting unit 23 can match the torque command Tr2 for the torque control to the torque command Tr(ts) for the position control by determining the torque command initial value Tr0 using formula (16) below.

$$\begin{matrix}Formula 16 & \\ Tr 0 = \frac{Tr 2 ( ts )}{kvi \cdot kvp} & ( 16 )\end{matrix}$$

In the third embodiment, since the torque command Tr1 for the position control matches the torque command Tr2 for the torque control at the time of switching, the switching of the switch 21 does not cause a sudden change in the operation of the object 7.

If a disturbance such as friction on the object 7 is sufficiently small, the torque command Tr1 for the position control has a very small value. That is, if a disturbance such as friction on the object 7 is sufficiently small, the object 7 can be driven with the torque command Tr1 of a small value. Consequently, without having to rewrite the value of the delay unit 10d at the switching time ts, the motor controller 102 can switch to the position control without causing a sudden change in the operation of the object 7.

The motor controller 102 of the third embodiment does not calculate the velocity command Vr and the model velocity Vm. Therefore, when determining the position command initial value Xr0, the position command initial value setting unit 13 of the third embodiment refers to the detected velocity VFB, and does not refer to the velocity command Vr and the model velocity Vm. That is, the position command initial value setting unit 13 of the first or second embodiment sets the position command initial value Xr0 with reference to the model velocity Vm, the detected velocity VFB, or the velocity command Vr, whereas the position command initial value setting unit 13 of the third embodiment sets the position command initial value Xr0 with reference to only the detected velocity VFB.

In the motor controller 102 of the third embodiment, the position control unit 6, the drive device 14, the velocity detection unit 11, the position detection unit 8, and the model initial value setting unit 12 perform the same operations as those in the first or second embodiment.

As described above, even in the case of switching from the torque control to the position control, the motor controller 102 of the third embodiment can prevent a sudden change in the mechanical operation, like the motor controller 101.

Although the first to third embodiments have described the case where the non-position control is the velocity control or the torque control, the non-position control may be sensorless control. In the velocity control, the detected velocity VFB is detected using an encoder. In the sensorless control, there is no sensor (velocity detection unit 11) that measures the velocity of the object 7, and the velocity is estimated from current and voltage.

The configurations described in the above embodiments illustrate an example, and can be combined with another known art. The embodiments can be combined with each other. The configurations can be partly omitted or changed without departing from the gist.

### REFERENCE SIGNS LIST

1 velocity command generation unit; 2 position command generation unit; 2a, 2d, 5b, 5d1, 5d5, 6a, 10a, 10c, 10f, 10h, 10k arithmetic unit; 2b velocity command calculation unit; 2c, 5a, 5d3, 5d4, 10b, 10l gain; 2e, 5c, 5d2, 10d, 10j delay unit; 2f, 4, 5e, 5f, 5g, 5h, 9, 10m, 21 switch; 3 switching command unit; 5A to 5C reference model unit; 5d low-pass filter; 6 position control unit; 6b position proportional gain; 7 object; 8 position detection unit; 10A, 10C velocity control unit; 10e velocity integral gain; 10g velocity proportional gain; 10i acceleration gain; 11 velocity detection unit; 12 model initial value setting unit; 13 position command initial value setting unit; 14 drive device; 22 torque command generation unit; 23 torque command initial value setting unit; 41 to 43, 51 to 56, 211 to 213 terminal; 101, 102 motor controller; CV velocity compensation signal; CX position compensation signal; Ps position control interval; Sw switching command; T reference model time constant; Tm model torque; Tr0 torque command initial value; Tr1 to Tr3 torque command; V velocity information; VFB detected velocity; Vm model velocity; Vr velocity command; Vrx command velocity; Vs velocity control interval; XFB detected position; XVr command; Xe command remaining distance; Xea actual remaining distance; Xm model position; Xm0 model position initial value; Xr position command; Xr0 position command initial value; Xt target stop position.

1.-12. (canceled)

13. A motor controller to control an object to be driven, switching between position control over the object and non-position control that is a control mode different from the position control, the motor controller comprising circuitry configured as:
a position command generator to generate a position command that is a command for the position control;
a reference model determiner to filter the position command with a filter, to determine a model position indicating a position corresponding to the filtered position command;
a velocity controller to determine, during the position control, a first torque command to drive the object, using a signal calculated based on the model position and a detected position that is a position detected on the object;
a model initial value setter to set a model position initial value, based on the detected position at a time of switching from the non-position control to the position control, the model position initial value being a signal used to calculate the model position at the time of switching; and
a position command initial value setter to set a position command initial value, based on velocity information, the detected position at the time of switching, and a transfer characteristic, the velocity information being a signal related to a velocity of the object at the time of switching, the transfer characteristic being a characteristic of a transfer function of the filter, wherein
the position command generator generates the position command at the time of switching, based on the position command initial value.

14. The motor controller according to claim 13, comprising a non-position command generator to generate a non-position command that is a command for the non-position control, wherein
the motor controller outputs, during the non-position control, a second torque command corresponding to the non-position command to drive the object, to a drive device to drive the object, and
the velocity controller outputs, at the time of switching, the first torque command corresponding to the position command at the time of switching, to the drive device.

15. The motor controller according to claim 13, wherein
the model initial value setter determines the model position initial value such that the model position at the time of switching matches the detected position at the time of switching.

16. The motor controller according to claim 13, wherein
the position command initial value setter uses a time constant of the transfer function as the transfer characteristic, and determines the position command initial value such that the position command at the time of switching matches a sum of the detected position at the time of switching and a multiplication result of multiplying the time constant by the velocity information at the time of switching.

17. The motor controller according to claim 13, wherein
the position command generator determines the position command such that a command velocity corresponding to a signal obtained by differentiating the position command at the time of switching with respect to time matches the velocity information at the time of switching.

18. The motor controller according to claim 14, wherein
the non-position control is velocity control to control the velocity of the object,
the non-position command generator is a velocity command generator to generate a velocity command that is a command for the velocity as the non-position command,
the reference model determiner determines a model velocity indicating a velocity corresponding to the velocity command and the transfer characteristic, and
the velocity controller calculates the second torque command based on the model velocity, and outputs the second torque command to the drive device during the non-position control.

19. The motor controller according to claim 18, wherein
the position command initial value setter sets the position command initial value by using at least one of the velocity command, the model velocity, and a detected velocity, as the velocity information at the time of switching, the detected velocity being a detected value of the velocity of the object.

20. The motor controller according to claim 18, wherein
the position command initial value setter uses a model position deviation that is a difference between a time integral value of the model velocity and a time integral value of the velocity command as the transfer characteristic, and sets the position command initial value such that the position command at the time of switching matches a sum of the detected position and the model position deviation.

21. The motor controller according to claim 14, wherein
the non-position control is torque control to control torque of the object,
the non-position command generator is a torque command generator to generate the second torque command as the non-position command, and
the torque command generator outputs the second torque command to the drive device during the non-position control.

22. The motor controller according to claim 21, wherein
the position command initial value setter sets the position command initial value by using a detected velocity as the velocity information at the time of switching, the detected velocity being a detected value of the velocity of the object.

23. The motor controller according to claim 22, further comprising circuitry configured as:
a torque command initial value setter to set a torque command initial value for use in generating the first torque command at the time of switching, the torque command initial value being an initial value of the first torque command, wherein
the velocity controller determines the first torque command at the time of switching, based on the torque command initial value.

24. The motor controller according to claim 23, wherein
the torque command initial value setter sets the torque command initial value such that the first torque command at the time of switching matches the second torque command at the time of switching.

25. A motor control system comprising:
the motor controller according to claim 14;
the drive device; and
the object.
